(19) United States
(12) Patent Application Publication
(10) Pub. No.: US 2008/0186629 A1
(43) Pub. Date: Aug. 7, 2008

(54) Method of producing a magnetic disk device with servo data recorded on magnetic disk, head amplifier for magnetic disk device and disk device

(75) Inventors: Takehiko Hamaguchi, Kanagawa (JP); Yukiya Shimizu, Kanagawa (JP); Satoshi Ohki, Kanagawa (JP); Hideaki Maeda, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Inc., Amsterdam (NL)

(21) Appl. No.: 12/009,215

(22) Filed: Jan. 16, 2008

(30) Foreign Application Priority Data
Jan. 17, 2007 (JP) 2007-007880

(51) Int. Cl. G11B 5/33

(52) U.S. Cl. 360/240; 360/110

(57) ABSTRACT

Embodiments of the present invention provide a method of producing a magnetic disk device in which a plurality of heads can appropriately record servo data on a magnetic disk. The method of producing the magnetic disk device according to one embodiment includes the steps of: attaching a magnetic disk, a plurality of heads and head amplifier circuit to the magnetic disk device; and recording the servo data input through the head amplifier circuit with the plurality of heads on the magnetic disk all at once; wherein the head amplifier circuit includes a plurality of amplifiers provided corresponding to the plurality of heads respectively and a plurality of registers which is provided corresponding to the plurality of amplifiers respectively and holds set values determining the amplification of the amplifiers, and the step of recording the servo data is conducted with the plurality of registers included in the head amplifier circuit individually set.

### CROSS-REFERENCE TO RELATED APPLICATION

The instant nonprovisional patent application claims priority to Japanese Patent Application No. 2007-007880 filed Jan. 17, 2007 and which is incorporated by reference in its entirety herein for all purposes.

### BACKGROUND OF THE INVENTION

Circular tracks are formed on a magnetic disk such as a hard disk used in a magnetic disk device. Servo data and user data are recorded on the tracks. The servo data is used to control the movement of a head at the time of recording or reproducing user data and includes address information for identifying track positions and burst patterns for a head for recognizing its position relative to tracks. The servo data is recorded on a magnetic disk before the magnetic disk device is shipped as a product.

The magnetic disk device usually incorporates a plurality of magnetic disks each has double faces used for recording data and a plurality of heads arranged corresponding to each of double recording faces of the magnetic disk. In the magnetic disk device with a plurality of heads, when servo data is recorded, the recording current of the servo data input from the outside is uniformly output to the plurality of heads to record the same servo data on each recording face of the magnetic disk all at once.

A plurality of heads may vary in characteristics from one to another, which in turn makes the recording currents required to appropriately record the servo data on the magnetic disk also different. For this reason, if the recording current of the servo data is uniformly output to the plurality of heads to record the servo data all at once, the servo data may not be appropriately recorded on the magnetic disk.

When the servo data is recorded in particular, the recording current is often set in the vicinity of the minimum current by which data can be recorded to reduce erase bands produced on both sides of formed tracks, so that variation in characteristics of the heads significantly influences.

It has been known that the above variation in characteristics is liable to occur when a vertical magnetic recording head is used. For the perpendicular magnetic recording system, the main magnetic pole of recording element of the head is tapered into a magnetic pole face generating a recording magnetic field opposite to the magnetic disk. The amount of recording magnetic field generated from the magnetic pole face is varied with shape or size of the tapered portion.

Japanese Patent Publication No. 09-115105 (“Patent Document 1”) discloses a technique whereby an optimum current used in recording user data is learnt for each head. This technique is such that the learned optimum recording current is set according to a switched head each time heads used for recording user data are switched one by one. This cannot solve the abovementioned problems caused when the servo data from a plurality of heads different in characteristics is recorded all at once.

### BRIEF SUMMARY OF THE INVENTION

Embodiments in accordance with the present invention provide a method of producing a magnetic disk device in which a plurality of heads can appropriately record servo data on a magnetic disk. The method of producing the magnetic disk device according to the particular embodiment of FIG. 1 includes the steps of: attaching a magnetic disk 11, a plurality of heads 12 and head amplifier circuit 16 to the magnetic disk device; and recording the servo data input through the head amplifier circuit 16 with the plurality of heads 12 on the magnetic disk 11 all at once; wherein the head amplifier circuit includes a plurality of amplifiers provided corresponding to the plurality of heads 12 respectively and a plurality of registers which is provided corresponding to the plurality of amplifiers respectively and holds set values determining the amplification of the amplifiers, and the step of recording the servo data is conducted with the plurality of registers included in the head amplifier circuit 16 individually set.

### BRIEF DESCRIPTION OF THE DRAWINGS

FIG. 1 is a block diagram illustrating an example of configuration of a servo data recording device.

FIG. 2 is a chart illustrating an example of recorded servo data.

FIGS. 3(A)-3(C) are diagrams of head of a magnetic disk device.

FIG. 4 is a diagram of a magnetic disk and head and of the magnetic disk device.

FIG. 5 is a block diagram illustrating an example of a first configuration of the head amplifier circuit.

FIG. 6 is a block diagram illustrating an example of a second configuration of the head amplifier circuit.

FIG. 7 is a flow chart illustrating an example of operation of the servo data recording device.

FIG. 8 is a block diagram illustrating an example of configuration of the magnetic disk device.

### DETAILED DESCRIPTION OF THE INVENTION

Embodiments of the present invention relate to a method of producing a magnetic disk device with servo data recorded on magnetic disk, a head amplifier for the magnetic disk device and the magnetic disk device.

Embodiments of the present invention have been made in view of the problems discussed above. It is one object of embodiments of the present invention to provide a method of producing a magnetic disk device with servo data recorded on the magnetic disk which is capable of appropriately recording the servo data on the magnetic disk with a plurality of heads.

To solve the above problems, an embodiment of a method according to the present invention of producing a magnetic disk device with servo data recorded on a magnetic disk is characterized by including the steps of: attaching a magnetic disk, a plurality of heads and head amplifier circuit to the magnetic disk device; and recording the servo data input through the head amplifier circuit with the plurality of heads on the magnetic disk all at once; wherein the head amplifier circuit includes a plurality of amplifiers which is provided corresponding to the plurality of heads respectively, amplifies and outputs recording current to the heads and a plurality of regulators which is provided corresponding to the plurality of amplifiers respectively and regulates the amplification of the amplifiers, and the step of recording the servo data is conducted with the plurality of regulators included in the head amplifier circuit individually set.

The method of producing a magnetic disk device with servo data recorded on a magnetic disk is characterized by further including a trial step of causing the plurality of heads to record data on the magnetic disk and reproduce the recorded data and determining the set values of the plurality of regulators included in the head amplifier circuit based on the obtained reproduced signals.

The method of producing a magnetic disk device with servo data recorded on a magnetic disk is characterized by including the head realizing the perpendicular magnetic recording system.

A head amplifier circuit applied to a magnetic disk device equipped with a plurality of heads for magnetically recording data on a magnetic disk according to embodiments of the present invention is characterized by comprising: a plurality of amplifiers which is provided corresponding to the plurality of heads respectively, amplifies and outputs recording current to the heads, and a plurality of regulators which is provided corresponding to the plurality of amplifiers respectively and regulates the amplification of the amplifiers.

The magnetic disk device according to embodiments of the present invention is characterized by including the abovementioned head amplifier circuit.

According to embodiments of the present invention, servo data can be appropriately recorded on a magnetic disk with a plurality of heads.

The embodiments of the present invention are described with reference to the drawings.

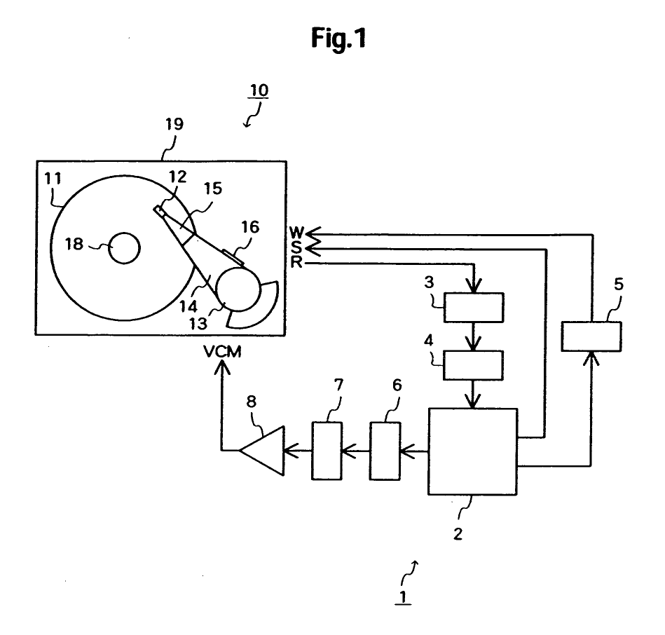

FIG. 1 is a block diagram illustrating an example of configuration of a servo data recording device 1. The figure also schematically illustrates a magnetic disk device 10 in which servo data is recorded by the servo data recording device 1. The servo data recording device 1 controls the components of the magnetic disk device 10 from the outside to record the servo data on a magnetic disk.

The servo data recording device 1 includes a control circuit 2, demodulator 3, analog-to-digital converter (AD converter) 4, servo signal generator 5, servo circuit 6, digital-to-analog converter (DA converter) 7 and voice coil motor (VCM) driver 8.

When the demodulator 3 receives a reproduced signal R from the magnetic disk device 10, the demodulator 3 demodulates the reproduced signal R and outputs the demodulated signal R to the control circuit 2 through the AD converter 4. The reproduced signal R is output from a head amplifier circuit 16 included in the magnetic disk device 10 (described in detail later).

The servo signal generator 5 generates a recording signal W representing the servo data under the control of the control circuit 2 and outputs the recording signal W to the magnetic disk device 10. The recording signal W is input into the head amplifier circuit 16 included in the magnetic disk device 10 (described in detail later).

The control circuit 2 controls the entire device and executes control for locating a head 12 included in the magnetic disk device 10 and recording the servo data on the magnetic disk 11. The control circuit 2 includes a central processing unit (CPU), random access memory (RAM) as a work area of the CPU and read only memory (ROM) storing programs required for the operation of the CPU.

Specifically, when the control circuit 2 receives the reproduced signal R from the magnetic disk device 10 and from the demodulator 3 through the AD converter 4, the control circuit 2 identifies the current position of the head 12 based upon the reproduced signal R and generates a position error signal (PES) which denotes a difference between a target position and the current position of the head 12 and outputs the signal to the servo circuit 6. The current position of the head 12 is a position of the head 12 relative to a track formed on the magnetic disk 11. In addition, the control circuit 2 renews the target position of the head 12 at a predetermined timing.

The control circuit 2 causes the servo signal generator 5 to generate the recording signal W at a predetermined timing and output the signal to the magnetic disk device 10. The control circuit 2 generates a control signal S for the head amplifier circuit 16 included in the magnetic disk device 10 and outputs the signal to the magnetic disk device 10. The control signal S is input into the head amplifier circuit 16 (described in detail later).

When the servo circuit 6 receives the position error signal from the control circuit 2, the servo circuit 6 generates a drive signal VCM for driving a voice coil motor 13 included in the magnetic disk device 10 based on the position error signal. The drive signal VCM is output to the voice coil motor 13 included in the magnetic disk device 10 through the DA converter 7 and the voice coil motor (VCM) driver 8.

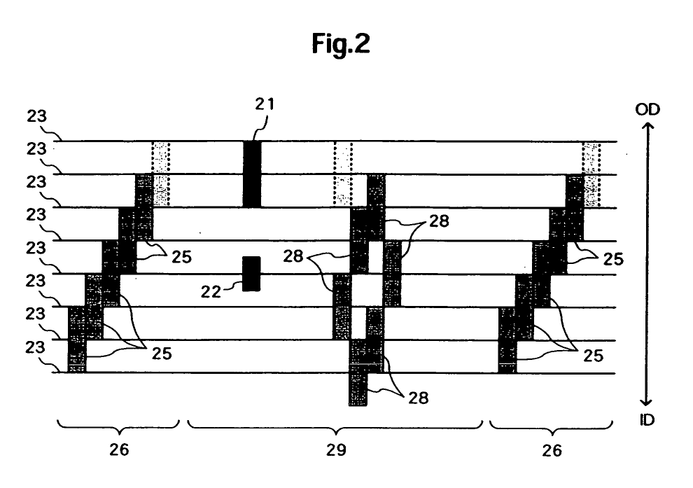

FIG. 2 is a chart illustrating an example of the servo data recorded by the servo data recording device 1. The figure partially expands the recording face of the magnetic disk 11 included in the magnetic disk device 10. The figure illustrates the images of a recording element 21 and reproducing element 22 of the head 12 projected on the magnetic disk 11. The images represent a positional relationship at the time of recording the servo data.

The figure shows the track center 23 of each track formed at the time of recording the servo data. The distance of the track is a half of a track (product track) at the time of recording or reproducing user data.

The servo data to be recorded on the magnetic disk 11 includes servo data for products such as a product burst pattern 28 used at the time of recording or reproducing user data and a radial burst pattern 25 for recording the product burst pattern.

The head 12 records the servo data for products such as the product burst pattern 28 and the radial burst pattern 25 for recording on a track basis with the recording element 21 thereof while moving from the inner periphery ID to the outer periphery OD of the magnetic disk 11. Incidentally, the head 12 may be reversely moved. The reproducing element 22 is situated on the rear side of the recording element 21 in the direction in which the head 12 moves and can reproduce the recording radial burst pattern 25 previously recorded by the recording element 21.

As described above, the recording radial burst pattern 25 previously recorded by the recording element 21 is reproduced, thereby the servo data recording device 1 uses a reproduced signal obtained from the recording radial burst pattern 25 for recording to enable performing a locating control of the head 12.

The tracks formed on the magnetic disk 11 are separated into a servo area 26 for recording and a product servo area 29. The radial burst pattern 25 for recording is recorded in the servo area 26 for recording, and servo data for products such as the product burst pattern 28 is recorded in the product servo area 29. The servo data for products includes address information (not shown) identifying the position of tracks as well as the product burst pattern 28.

The servo area 26 for recording on which user data is overwritten later is changed to a user data area. The recording radial burst pattern 25 is recorded in the servo area 26 with the radial burst pattern 25 shifted in position in the direction in which the magnetic disk 11 rotates with respect to the radial burst pattern 25 for recording recorded on an adjacent track. Each track formed on the magnetic disk 11 is defined by the radial burst pattern 25 for recording and the center in the radial direction of the magnetic disk 11 in the radial burst pattern 25 for recording is a track center 23.

Although the servo data for products including the product burst pattern 28 and the radial burst pattern 25 for recording are sequentially recorded on each track in the above example, instead of the above, for example, the radial burst pattern 25 for recording is all recorded in advance and then the servo data for products may be sequentially recorded on each track while performing location by using the radial burst pattern 25 for recording.

A detailed configuration of the magnetic disk device 10 in which the servo data is recorded by the servo data recording device 1 is described below with reference to FIG. 1. The magnetic disk device 10 includes in its housing 19 the magnetic disk 11, head 12, voice coil motor 13, carriage 14, suspension arm 15, head amplifier circuit 16 and spindle motor 18.

The magnetic disk 11 is fixed to the spindle motor 18 to be rotated. The head 12 magnetically records and reproduces data on and from the magnetic disk 11. The head 12 is supported by the leading edge of the suspension arm 15. The suspension arm 15 is attached to the carriage 14 integrated with the voice coil motor 13 and pivotably driven around the center of a pivot. This relatively moves the head 12 above the magnetic disk 11 in a substantial radial direction.

A flexible circuit (not shown) connected to the head 12 is arranged on the side of the carriage 14 and equipped with the head amplifier circuit 16.

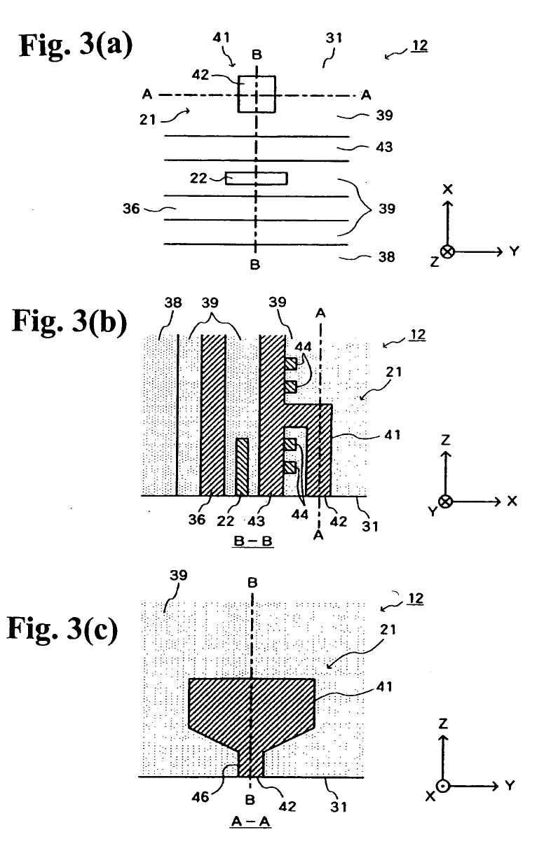

FIG. 3 illustrates an example of a detailed configuration of the head 12. FIG. 3(A) is a diagram illustrating a air bearing surface (ABS) 31 (a surface opposing the magnetic disk 11) of the head 12. FIG. 3(B) is a cross section taken along the line B-B in FIG. 3(A). FIG. 3(C) is a cross section taken along the line A-A in FIG. 3(A). Where, reference character X denotes the radial direction in which the head 12 is pivotably driven and the negative side thereof is toward the pivotal shaft of the voice coil motor 13. Reference character Z indicates the direction perpendicular to the main surface of the magnetic disk 11 and the positive side thereof is toward the direction in which the head 12 floats.

The head 12 is configured as a thin film magnetic head realizing a perpendicular magnetic recording system. The head 12 has the following layered structure. Where, the upper side is taken to be a lamination direction in the layered structure, i.e., the plus direction of X. The reproducing element 22 is arranged above a nonmagnetic substrate 38 fixed to a slider (not shown) through a magnetic shield 36. The reproducing element 22 is composed of elements such as a GMR element reproducing data recorded on the magnetic disk 11 and arranged to be exposed on the air bearing surface (ABS) 31. In addition, the recording element 21 is provided above the reproducing element 22. The recording element 21 records data on the magnetic disk 11. The space between these members is filled with an intermediate layer 39 of ceramic such as alumina.

The recording element 21 includes a main magnetic pole 41 with a magnetic pole face 42 exposed on the air bearing surface (ABS) 31, auxiliary magnetic pole 43 and coil 44. The main magnetic pole 41 maintains a predetermined space with respect to the auxiliary magnetic pole 43 and is attached to the auxiliary magnetic pole 43, with its portion opposite to the magnetic pole face 42 bent. The coil 44 is of a spiral shape surrounding a portion where the coil 44 is attached to the auxiliary magnetic pole 43 of the main magnetic pole 41, receives a recording signal from the outside and generates a recording magnetic field vertical toward the magnetic disk 11 from the magnetic pole face 42 at the leading edge of the main magnetic pole 41. The auxiliary magnetic pole 43 is a layer to which the recording magnetic field generated vertically toward the magnetic disk 11 from the magnetic pole face 42 of the main magnetic pole 41 turns around the inside of the magnetic disk 11 and returns. The auxiliary magnetic pole 43 also functions as a magnetic barrier.

The main magnetic pole 41 is tapered to the magnetic pole face 42 so that the recoding magnetic field is concentrated in the magnetic pole face 42 and a leading edge portion 46 including the magnetic pole face 42 has a predetermined length.

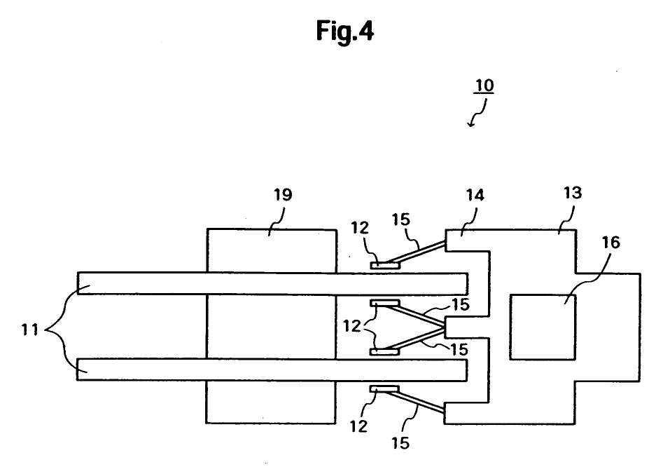

As illustrated in FIG. 4, the magnetic disk device 10 is equipped with a plurality of heads 12 described above. In the magnetic disk device 10, a plurality of magnetic disks 11 each has double faces used for recording data is fixed to the spindle motor 19. A plurality of suspension arms 15 is extended from the carriage 14 corresponding to each recording face of the magnetic disks 11 and the heads 12 are supported by the leading edges of the suspension arms 15.

The head amplifier circuit 16 separately amplifies the recording signal W of servo data input from the servo data recording device 1 and outputs the signal to the heads 12, thereby recording the servo data on each recording face of the magnetic disk 11 all at once. The detailed configuration of the head amplifier circuit 16 is described below.

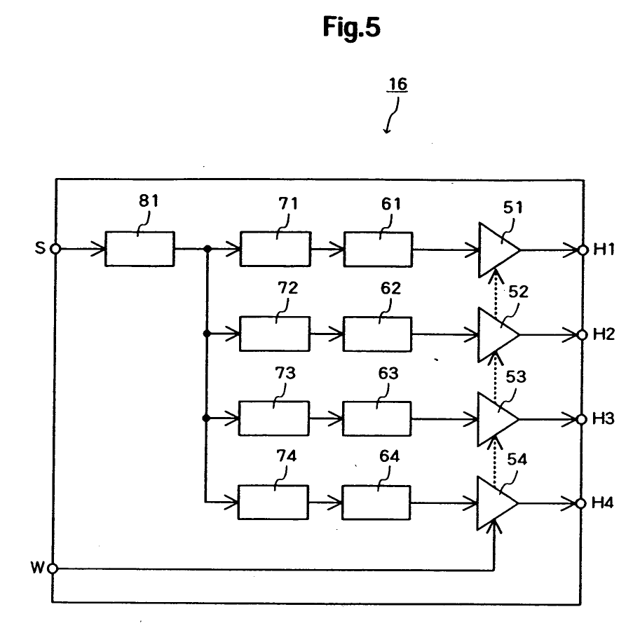

FIG. 5 is a block diagram illustrating an example of a first configuration of the head amplifier circuit 16. The reproducing system for amplifying the reproduced signal R input from the head 12 is the same in configuration as the conventional example, so that it is omitted.

The first configuration example of the head amplifier circuit 16 includes a plurality of recording amplifiers 51 to 54, a plurality of digital-to-analog converters (DA converters) 61 to 64, a plurality of registers (regulators) 71 to 75 and serial interface 81.

The plurality of recording amplifiers 51 to 54 are connected to a plurality of head gates H1 to H4 corresponding to the above plurality of heads 12 respectively. The plurality of DA converters 61 to 64 are connected to the recording amplifiers 51 to 54 respectively. The plurality of registers 71 to 74 are connected to the DA converters 61 to 64 respectively. The serial interface 81 is connected to the registers 71 to 74. The serial interface 81 is connected to a control gate to which the control signal S is input.

The recording amplifiers 51 to 54 amplify the recording signal W input from a gate (write gate) to which the recording signal W is input and outputs the signal to corresponding head gates H1 to H4.

When the servo data is recorded on the magnetic disk 11 by the servo data recording device 1, the recording amplifiers 51 to 54 amplify each of the recording signals W of servo data input into the write gate from the servo data recording device 1 and outputs the signals to corresponding head gates H1 to H4 all at once.

When user data is recorded on the magnetic disk 11 by the magnetic disk device 10, the control signal S input into the control gate from higher-order components causes any of the recording amplifiers 51 to 54 to be operable. The recording amplifier caused to be operable amplifies the recording signal W of user data input into the write gate from the higher-order components and outputs the signal to corresponding head gate.

The registers 71 to 74 have set-values for determining the amplification of the recording amplifiers 51 to 54 respectively and output the set values to the recording amplifiers 51 to 54 through the DA converters 61 to 64 to individually adjust the amplification of the recording amplifiers 51 to 54. The set values held by the registers 71 to 74 are set by the control signal S input into the control gate.

Thus, in the head amplifier circuit 16 of the first configuration example, the plurality of registers (regulators) 71 to 74 and the plurality of DA converter 61 to 64 corresponding to the plurality of recording amplifiers 51 to 54 are provided therein to enable the amplification of the recording amplifiers 51 to 54 to be individually adjusted.

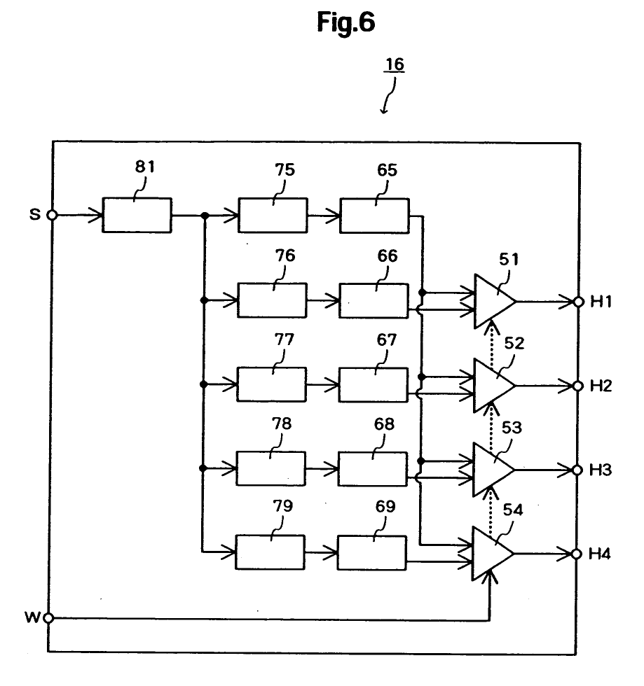

FIG. 6 is a block diagram illustrating an example of a second configuration of the head amplifier circuit 16. The configuration of the reproducing system is also omitted from the figure. The parts duplicated with the first configuration example are provided with the same reference numerals to omit a detailed description thereof.

The second configuration example of the head amplifier circuit 16 includes a plurality of recording amplifiers 51 to 54, main digital-to-analog converter (main DA converter) 65, a plurality of sub digital-to-analog converters (sub DA converters) 66 to 69, main register 75, a plurality of sub registers (regulators) 76 to 79 and serial interface 81.

The plurality of recording amplifiers 51 to 54 are connected to a plurality of head gates H1 to H4 corresponding to the above plurality of heads 12 respectively. The plurality of sub DA converters 66 to 69 are connected to the recording amplifiers 51 to 54 respectively. The main DA converter 65 is connected to the recording amplifiers 51 to 54. The plurality of sub registers 76 to 79 are connected to the sub DA converters 66 to 69 respectively. The main register 75 is connected to the main DA converter 65. The serial interface 81 is connected to the sub registers 76 to 79 and the main register 75.

The main register 75 has set-values for determining a reference for amplification of the recording amplifiers 51 to 54 and outputs the set values to the recording amplifiers 51 to 54 through the main DA converter 65 to increase the amplification of the recording amplifiers 51 to 54 to the reference. The sub registers 76 to 79 have set-values for determining offsets from the reference for amplification of the recording amplifiers 51 to 54 and output the set values to the recording amplifiers 51 to 54 through the sub DA converters 66 to 69 to individually adjust the amplification of the recording amplifiers 51 to 54 with reference to the reference. The set values held by the main register 75 and the sub registers 76 to 79 are set by the control signal S input into the control gate.

Thus, in the head amplifier circuit 16 of the second configuration example, the plurality of sub registers 76 to 79 and the plurality of sub DA converters 66 to 69 corresponding to the plurality of recording amplifiers 51 to 54 are provided therein to enable the amplification of the recording amplifiers 51 to 54 to be individually adjusted.

The main register 75 and the main DA converter 65 increase the amplification of the recording amplifiers 51 to 54 to the reference and the sub registers 76 to 79 and the sub DA converters 66 to 69 simply individually adjust the amplification of the recording amplifiers 51 to 54 with reference to the reference. This simplifies the configuration of the sub registers 76 to 79 and the sub DA converters 66 to 69 to downsize the head amplifier circuit 16.

The detailed operation of the servo data recording device 1 is described below.

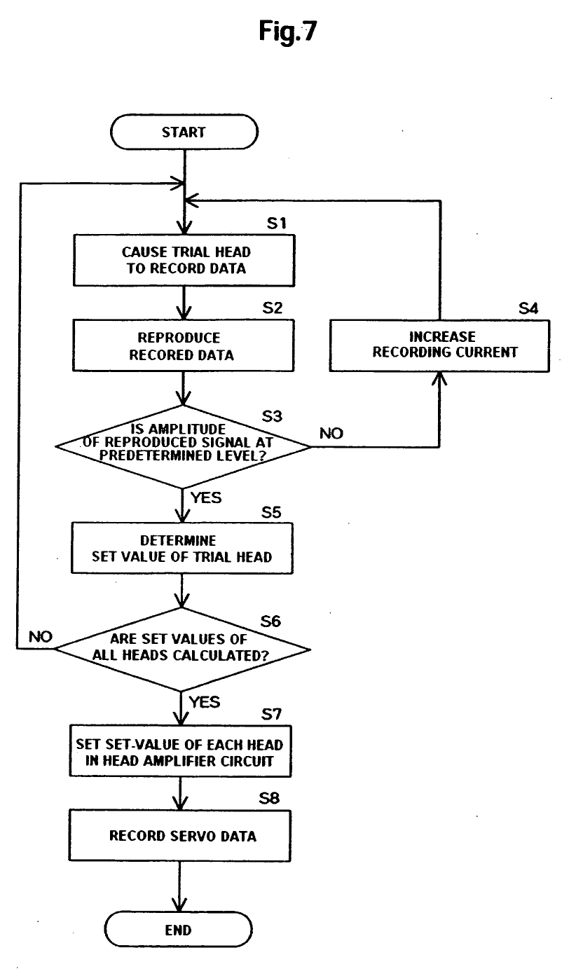

FIG. 7 is a flow chart showing an example of operation of the servo data recording device 1. The flow chart shows a trial step (S1 to S6), setting step (S7) and servo recording step (S8) executed by the servo data recording device 1. These operations are performed following an assembly step at which the magnetic disks 11, the plurality of heads 12 and the head amplifier circuit 16 are mounted in the magnetic disk device 10 at the production process of the magnetic disk device 10.

Firstly, one of a plurality of the heads 12 is taken to be trial head, and the servo data recording device 1 causes the trial head to record trial data on the magnetic disk 11 (S1). This operation is performed such that the servo data recording device 1 outputs the recording signal W representing the trial data to the head amplifier circuit 16 and the control signal S including information causing the recording amplifiers (refer to FIGS. 5 and 6) connected to the trial head to be operable and information setting set-values for determining the amplification of the recording amplifier in the register (refer to FIGS. 5 and 6). An initial set value to be set in the register is such that the amplification of the recording amplifier becomes lower enough.

The servo data recording device 1 reproduces the trial data recorded on the magnetic disk 11 with the trial head (S2). This operation is performed in such a manner that the servo data recording device 1 outputs the control signal S including information causing a reproducing amplifier (not shown) connected to the trial head to be operable to the head amplifier circuit 16 and obtains the reproduced signal R formed such that the trial head reproduces and amplifies the trial data from the head amplifier circuit 16.

The servo data recording device 1 determines whether the amplitude of the reproduced signal R obtained from the head amplifier circuit 16 is at a predetermined level (S3). If the amplitude of the reproduced signal R is not at the predetermined level (S3: NO), the servo data recording device 1 renews the set value held in the register and increases the amplification of the recording amplifier (S4) and repeats the operations of steps 1 and 2 until the amplitude of the reproduced signal R reaches the predetermined level.

If the amplitude of the reproduced signal R reaches the predetermined level (S3: YES), the servo data recording device 1 determines the set value set in the register last as the set value for recording the servo data (S5).

The servo data recording device 1 executes the operations of the above steps S1 to S5 for all the plurality of heads 12 and determines set values to be set in the registers 71 to 74 in the time of recording the servo data (S6).

The reason why set values to be set in the register are determined (that is to say, why the amplitude of the recording amplifier is determined) based on the reproduced signal R is that the magnitude of the recording magnetic field emitted from the trial head when the trial data is recorded on the magnetic disk 11 is reflected in the amplitude of the reproduced signal R when the trial data is reproduced from the magnetic disk 11. In other words, obtaining such amplification of the recording amplifier that the magnitude of the recording magnetic field emitted from the trial head is at a predetermined level for all the plurality of heads 12 enables aligning the magnitude of the recording magnetic field emitted from the plurality of heads 12 with the predetermined level.

After that, the servo data recording device 1 outputs the control signal S to the head amplifier circuit 16 and sets the set values determined at the trial steps (S1 to S6) in the registers 71 to 74 respectively (S5: setting step). The servo data recording device 1 outputs the recording signal W expressing servo data to the head amplifier 16 with the individual set values set in the registers 71 to 74 to cause the plurality of heads 12 to record servo data on the magnetic disk 11 all at once (S6: servo recording step).

Since the servo data recording device 1 sets the set values determined at the trial step (S1 to S6) in the registers 71 to 74 to allow aligning the magnitude of the recording magnetic field emitted from the plurality of heads 12 with the predetermined level, the plurality of heads 12 can record servo data on the magnetic disk 11 all at once with the magnitude of the recording magnetic field emitted from the plurality of heads 12 aligned with an appropriate level.

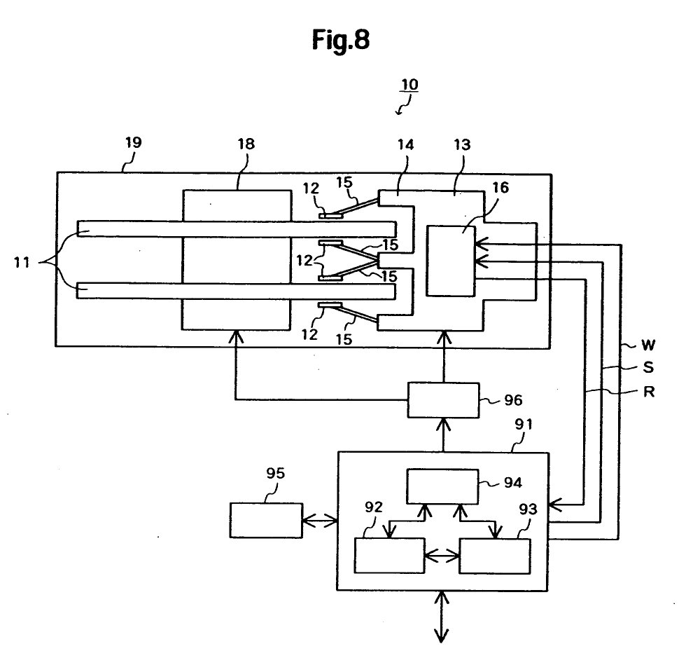

The magnetic disk device 10 thus produced is described below. FIG. 8 is a block diagram illustrating an example of configuration of the magnetic disk device 10.

As described above, the magnetic disk device 10 includes in its housing 19 the magnetic disk 11, head 12, voice coil motor 13, carriage 14, suspension arm 15, head amplifier circuit 16 and spindle motor 18.

The magnetic disk device 10 has a main circuit portion 91, buffer memory 95 and motor driver 96 outside its housing 19. The main circuit portion 91 includes a micro-processing unit (MPU) 92, hard disk controller (HDC) 93 and read/write channel (R/W channel) 94.

The MPU 92 controls the entire device. The MPU 92 operates in accordance with the program stored in a memory (not shown). Specifically, for example, when the MPU 92 receives a recording command or reproducing command from a host, the MPU 92 controls the voice coil motor 13 according to the command so that the magnetic head 12 moves onto a desired track of the magnetic disk 11 to cause the magnetic head 12 to record and reproduce user data.

When the MPU 92 receives the servo data reproduced by the magnetic head 12 from the R/W channel 94, the MPU 92 identifies the current position of the magnetic head 12 based on the servo data to obtain a position error signal (PES) representing a positional error between a target position of the magnetic head 12 written in the recording or the reproducing command and the current position of the magnetic head 12. The MPU 92 generates a driving signal for the voice coil motor 13 from the obtained position error signal and outputs the driving signal to the motor driver 96.

When the motor driver 96 receives the driving signal for the voice coil motor 13 from the MPU 92, the motor driver 96 converts the driving signal into an analog signal, amplifies the analog signal and outputs it to the voice coil motor 13. In addition, when the motor driver 96 receives the driving signal for the spindle motor 18 from the MPU 92, the motor driver 96 converts the driving signal into an analog signal, amplifies the analog signal and outputs it to the spindle motor 18.

The HDC 93 includes an interface controller, error correction circuit, buffer controller and servo controller.

When the HDC 93 receives user data to be recorded on the magnetic disk 11 from the host, the HDC 93 outputs the user data to the R/W channel 94. In addition, when the HDC 93 receives user data reproduced from the magnetic disk 11 from the R/W channel 94, the HDC 93 transmits the user data to the host. At this point, the HDC 93 is controlled by the MPU 92 to temporally store the user data in the buffer memory 95.

When the R/W channel 94 receives the user data from the HDC 93, the R/W channel 94 modulates the user data, converts it into an analog signal and outputs the recording signal W to be generated to the head amplifier circuit 16. In addition, when the R/W channel 94 receives the reproduced signal R which has been reproduced from the magnetic disk 11 from the head amplifier circuit 16, the R/W channel 94 converts the reproduced signal R into a digital data, demodulates the digital data and outputs the demodulated data to the HDC 93. The R/W channel 94 samples servo data from the reproduced signal R which has been reproduced from the magnetic disk 11 at a predetermined sampling period and outputs it to the MPU 92.

The MPU 92 outputs to the head amplifier circuit 16 the control signal S which is used when user data is recorded or reproduced and used for selecting a head from among a plurality of heads 12.

Below is described in detail how to record user data. When the R/W channel 94 outputs the recording signal W of user data to the head amplifier circuit 16, the MPU 92 outputs the control signal S including information causing the recording amplifiers connected to heads to be used to be operable to the head amplifier circuit 16.

As illustrated in FIGS. 5 and 6, since the head amplifier circuit 16 includes a plurality of registers 71 to 75 and a plurality of DA converters 61 to 64 (or a plurality of sub registers 76 to 79 and a plurality of sub DA converters 66 to 69) corresponding to a plurality of recording amplifiers 51 to 54, set values for determining the amplification of the recording amplifiers 51 to 54 can be held in the plurality of registers 71 to 75.

For this reason, when a head to be used is selected from among a plurality of heads 12, the MPU 92 causes the control signal S not to include information on set values held in the registers, but to include information causing the recording amplifier connected to the head to be used to be operable, thereby the recording amplifiers 51 to 54 can be used with their amplification individually adjusted. In other words, not only data quantity of the control signal S can be reduced, but also the heads to be used can be simply and quickly switched, in addition, the heads can be used with the amplification of the recording amplifier appropriately adjusted.

What is claimed is:

1. A method of producing a magnetic disk device with servo data recorded on a magnetic disk characterized by comprising the steps of:
attaching a magnetic disk, a plurality of heads, and head amplifier circuit to the magnetic disk device; and
recording the servo data input through the head amplifier circuit with the plurality of heads on the magnetic disk all at once; wherein
the head amplifier circuit includes a plurality of amplifiers which is provided corresponding to the plurality of heads respectively, amplifies and outputs recording current to the heads and the plurality of regulators which is provided corresponding to the plurality of amplifiers respectively and regulates the amplification of the amplifiers, and the step of recording the servo data is conducted with the plurality of regulators included in the head amplifier circuit individually set.

2. The method of producing magnetic disk device with servo data recorded on a magnetic disk according to claim 1 characterized by further comprising:
a trial step of causing the plurality of heads to record data on the magnetic disk and reproduce the recorded data and determining the set values of the plurality of regulators included in the head amplifier circuit based on the obtained reproduced signals.

3. The method of producing the magnetic disk device with servo data recorded on a magnetic disk according to claim 1, wherein
the head realizes the perpendicular magnetic recording system.

4. The method of producing the magnetic disk device with servo data recorded on a magnetic disk according to claim 2, wherein
the head realizes the perpendicular magnetic recording system.

5. A head amplifier circuit applied to a magnetic disk device equipped with a plurality of heads for magnetically recording data on a magnetic disk, the head amplifier circuit comprising:
a plurality of amplifiers which is provided corresponding to the plurality of heads respectively, amplifies and outputs recording current to the heads, and
a plurality of regulators which is provided corresponding to the plurality of amplifiers respectively and regulates the amplification of the amplifiers.

6. A magnetic disk device comprising:
a magnetic disk;
a plurality of heads for magnetically recording data on the magnetic disk; and
a head amplifier circuit comprising:
a plurality of amplifiers which is provided corresponding to the plurality of heads respectively, amplifies and outputs recording current to the heads, and
a plurality of regulators which is provided corresponding to the plurality of amplifiers respectively and regulates the amplification of the amplifiers.

7. The magnetic disk device of claim 6 wherein:
the plurality of heads record data on the magnetic disk and reproduce the recorded data and determining the set values of the plurality of regulators included in the head amplifier circuit based on obtained reproduced signals.

8. The magnetic disk device of claim 6 wherein
servo data is recorded on a magnetic disk, and
wherein the head realizes the perpendicular magnetic recording system.

9. The magnetic disk device of claim 7 wherein
servo data is recorded on a magnetic disk, and
wherein the head realizes the perpendicular magnetic recording system.
